(19) United States
(12) Patent Application Publication
(10) Pub. No.: US 2009/0110787 A1
(43) Pub. Date: Apr. 30, 2009

(54) Additive delivery laminate containing styrene-ethylene/butylene-styrene copolymer

(76) Inventors: David R. Kyle, Moore, SC (US); Milissa Smith, Greer, SC (US)

Correspondence Address: Rupert B. Hurley Jr.;Sealed Air Corporation, P.O. Box 464, Duncan, SC, 29334, US

(21) Appl. No.: 11/977,654

(22) Filed: Oct. 24, 2007

(51) Int. Cl. A23L 1/22; A23L 1/27; B65D 85/00

(52) U.S. Cl. 426/132; 426/650; 426/531

(57) ABSTRACT

An additive delivery laminate is suitable for packaging a food product which is cooked in the package, with an additive transferring from the laminate to the food product. The additive delivery laminate has a substrate and an additive delivery layer. The additive delivery layer contains styrene-ethylene/butylene-styrene copolymer and additive granules containing a colorant, flavorant, and/or odorant. The styrene-ethylene/butylene-styrene copolymer has a styrene to ethylene/butylene weight ratio of from 5:95 to 50:50 and a Brookfield Viscosity of from 500 to 100,000 centipoise measured as a 25 weight percent solution in toluene at 77° F.

### FIELD

The present invention relates generally to packaging, and more specifically to thermoplastic laminates, and methods of using same especially to package and heat or cook a food product to deliver enhanced flavor, aroma, and/or color to the food product.

### BACKGROUND

The commercial food packaging industry has for many years carried out processes in which a food additive is used to modify a food product by imparting a desired color, flavor, or odor to the product. In the meat industry, this has included modification of a meat product during cooking of the meat. Smoke flavor and caramel coloring have been used to modify meat products.

There remains a need to improve the manner in which color, flavor, and odor food additives are combined with food products, and to improve the quality of the resulting modified food product. Problems experienced in the prior art include, among others, uneven distribution of the food additive in or on the food product, inability to transfer enough food additive to the food product, inadequate adhesion of the food additive to the food product upon removing the package from the food product, and poor appearance of the food product after transfer of the food additive to the food product. It would be desirable to provide a process or product which addresses one or more of these areas.

### SUMMARY OF THE INVENTION

As a first aspect, an additive delivery laminate comprises a substrate and an additive delivery layer, with the additive delivery layer comprising a water-insoluble thermoplastic polymer and additive granules comprising at least one member selected from the group consisting of colorant, flavorant, and odorant, the water-insoluble thermoplastic polymer comprises a styrene-ethylene/butylene-styrene triblock copolymer (“SEBS”) having a styrene to ethylene/butylene weight ratio of from 5:95 to 50:50 and a Brookfield Viscosity of from 500 to 100,000 centipoise measured as a 25 weight percent solution in toluene at 77° F. The styrene-ethylene/butylene-styrene triblock copolymer is present in the additive delivery layer in an amount of from about 10 to 90 weight percent based on total layer weight. The additive granules are present in the additive delivery layer in an amount of from about 90 to 10 weight percent based on total layer weight.

As a second aspect, an additive delivery laminate comprises a substrate and an additive delivery layer, the additive delivery layer comprising a water-insoluble thermoplastic polymer and additive granules comprising at least one member selected from the group consisting of colorant, flavorant, and odorant, the water-insoluble thermoplastic polymer comprising a blend of: (A) a first styrene-ethylene/butylene-styrene triblock copolymer, the first styrene-ethylene/butylene-styrene triblock copolymer having a styrene to ethylene-butylene weight ratio of up to 20:80 (or from 1:99 to 20:80) and a Brookfield Viscosity of from 500 to 100,000 centipoise measured as a 25 weight percent solution in toluene at 77° F.; and (B) a second styrene-ethylene/butylene-styrene triblock copolymer, the second styrene-ethylene/butylene-styrene triblock copolymer having a styrene to ethylene-butylene weight ratio of at least 21:80 (or from 21:80 to 50:50) and a Brookfield Viscosity of from 500 to 100,000 centipoise measured as a 25 weight percent solution in toluene at 77° F. The first styrene-ethylene/butylene-styrene triblock copolymer is present in the additive delivery layer in an amount of from about 6.7 to 60 weight percent based on total layer weight. The second styrene-ethylene/butylene-styrene triblock copolymer is present in the additive delivery layer in an amount of from about 3.3 to 30 weight percent based on total layer weight. The additive granules are present in the additive delivery layer in an amount of from about 90 to 10 weight percent based on total layer weight.

A third aspect is directed to a packaging article comprising an additive delivery laminate adhered to itself or another component of the packaging article, the additive delivery laminate being in accordance with the first aspect set forth above, or the second aspect set forth above.

### BRIEF DESCRIPTION OF THE DRAWINGS

FIG. 1 illustrates a schematic view of a process for making a substrate film in accordance with the present invention.

FIG. 2 illustrates a lay-flat view of a bag made from the additive transfer laminate in accordance with the present invention.

FIG. 3 illustrates a packaged product containing the additive transfer laminate in accordance with the present invention.

FIG. 4 illustrates a perspective view of an alternative packaged product containing the additive transfer laminate in accordance with the present invention.

FIG. 5 illustrates a first embodiment of a cross-sectional view through line 5-5 of the packaged product illustrated in FIG. 4.

FIG. 6 illustrates a cross-sectional view of an alternative packaged product.

FIG. 7 illustrates a cross-sectional view of another alternative packaged product.

FIG. 8 illustrates a schematic view of a process for coating a substrate film to make the additive delivery laminate of the invention

### DETAILED DESCRIPTION

The phrase “additive delivery layer” refers to a layer of the laminate which contains both the water-insoluble thermoplastic polymer and additive-containing granules. In operation, the granules in the additive delivery layer transfer to the food product. Preferably, the additive delivery layer is prepared by combining the thermoplastic polymer an organic solvent, and the additive granules, with the thermoplastic polymer dissolving in the organic solvent, with the additive granules then being stirred into the solution. The resulting slurry is then deposited onto a substrate (which can, for example, be a film, either monolayer or multilayer), and the solvent evaporated, leaving the additive delivery coating affixed onto the substrate (i.e., bonded to the substrate), resulting in the additive delivery laminate. Upon evaporation of the solvent, the additive delivery layer can be present in an amount within the range of from about 5 to about 50 grams per square meter; or from about 10 to about 30 grams per square meter; or from about 10 to about 20 grams per square meter, or from about 20 to about 30 grams per square meter. The additive delivery layer can be an outer layer of the laminate.

The thermoplastic polymer of the additive delivery layer comprises at least one water-insoluble polymer. The water-insoluble thermoplastic polymer can made up 100% of the polymer of the additive delivery layer. If a blend of water-soluble polymer and water-insoluble thermoplastic polymer is present in the additive delivery layer, preferably the amount of water-soluble polymer is less than 50 percent, based on total weight of the water-insoluble thermoplastic polymer in the additive delivery layer, for example within a range of from about 1 to about 40 percent, or within from about 1 to 20 percent, or within from about 1 to about 10 percent, based on total weight of the water-insoluble thermoplastic polymer in the additive delivery layer.

In one embodiment, the styrene-ethylene/butylene-styrene triblock copolymer (also referred to herein as “SEBS”) can have a styrene to ethylene/butylene weight ratio of from 8:92 to 40:60 and a Brookfield Viscosity of from 1,000 to 20,000 centipoise measured as a 25 weight percent solution in toluene at 77° F. The SEBS can be present in the additive delivery layer in an amount of from about 15 to 50 weight percent based on total layer weight, and the additive granules can be present in the additive delivery layer in an amount of from about 85 to 50 weight percent based on total layer weight.

In another embodiment, the SEBS can have a styrene to ethylene/butylene weight ratio of from 10:90 to 38:62 and a Brookfield Viscosity of from 2,000 to 8,000 centipoise measured as a 25 weight percent solution in toluene at 77° F. The SEBS can be present in the additive delivery layer in an amount of from about 20 to 40 weight percent based on total layer weight, and the additive granules can be present in the additive delivery layer in an amount of from about 80 to 60 weight percent based on total layer weight.

In another embodiment, the additive delivery layer comprises a blend of a first SEBS and a second SEBS, with the first SEBS having a styrene to ethylene/butylene weight ratio of up to 17:83 (or from 1:99 to 17:83) and a Brookfield Viscosity of from 1,000 to 20,000 centipoise measured as a 25 weight percent solution in toluene at 77° F. The second SEBS has a styrene to ethylene/butylene weight ratio of at least 24:86 (or from 24:86 to 50:50) and a Brookfield Viscosity of from 1,000 to 20,000 centipoise measured as a 25 weight percent solution in toluene at 77° F. The first SEBS can be present in the additive delivery layer in an amount of from about 13 to 33.3 weight percent, based on total layer weight, and the second styrene-ethylene/butylene-styrene triblock copolymer can be present in the additive delivery layer in an amount of from about 7 to 16.7 weight percent, and the additive granules are present in the additive delivery layer in an amount of from about 80 to 50 weight percent, based on total layer weight.

In another embodiment, the additive delivery layer comprises a blend of a first SEBS and a second SEBS, with the first SEBS having a styrene to ethylene/butylene weight ratio of up to 15:85 (or from 1:99 to 15:85) and a Brookfield Viscosity of from 2,000 to 8,000 centipoise measured as a 25 weight percent solution in toluene at 77° F. The second SEBS has a styrene to ethylene/butylene weight ratio of at least 27:83 (or from 27:83 to 50:50) and a Brookfield Viscosity of from 2,000 to 8,000 centipoise measured as a 25 weight percent solution in toluene at 77° F. The first SEBS can be present in the additive delivery layer in an amount of from about 16.7 to 26.7 weight percent, based on total layer weight, and the second styrene-ethylene/butylene-styrene triblock copolymer can be present in the additive delivery layer in an amount of from about 8.3 to 13.3 weight percent, and the additive granules are present in the additive delivery layer in an amount of from about 75 to 60 weight percent, based on total layer weight.

In another embodiment, the additive delivery layer comprises a blend of a first SEBS and a second SEBS, with the first SEBS having a styrene to ethylene/butylene weight ratio of from 10:90 to 15:85 and a Brookfield Viscosity of from 3,000 to 5,000 centipoise measured as a 25 weight percent solution in toluene at 77° F. The second SEBS has a styrene to ethylene/butylene weight ratio of from 25:75 to 35:65 and a Brookfield Viscosity of from 1,500 to 2,000 centipoise measured as a 25 weight percent solution in toluene at 77° F. The first SEBS can be present in the additive delivery layer in an amount of from about 16.7 to 26.7 weight percent, based on total layer weight, and the second styrene-ethylene/butylene-styrene triblock copolymer can be present in the additive delivery layer in an amount of from about 8.3 to 13.3 weight percent, and the additive granules are present in the additive delivery layer in an amount of from about 75 to 60 weight percent, based on total layer weight.

The additive delivery layer comprises at least one SEBS as set forth above. However, the additive delivery layer may further comprise an additional and different water-insoluble polymer selected from the group consisting of styrene/butadiene copolymer (i.e., styrene/butadiene rubber), isobutylene/isoprene copolymer (e.g., butyl rubber), crosslinked butyl rubber, polyisoprene, polyisobutylene, polybutylene, isobutylene/isoprene copolymer, styrene/isobutylene copolymer, ethylene/vinyl acetate copolymer, ethylene/butyl acrylate copolymer, ethylene/vinyl alcohol copolymer, ethylene/propylene copolymer, propylene/ethylene copolymer, polypropylene, polybutadiene, polyethylene, ethylene/alpha-olefin copolymer, ethylene/cyclo-olefin copolymer, polyvinyl acetate, cellulose triacetate, natural rubber, chicle, and balata rubber.

Adhesive legs are portions of an adhesive layer which strongly adhere to the adherend (e.g., the cooked food product). During separation of the adhesive layer (e.g., the additive delivery layer) from an object to which the adhesive is adhered, portions of the adhesive layer may adhere so strongly that they cause the adhesive material to stretch out to form visibly apparent connecting strands called “legs”. Adhesive legs are undesirable as they are present only if the polymer is adhering to the food. Legs are indicative of two potential undesirable consequences of adhesion of polymer to food product. The first undesirable consequence is transfer of pieces of polymer to the cooked food product. The second undesirable consequence is pulling pieces of food product off onto the laminate as it is being peeled from the cooked food product (e.g., “meat pull-off”). It is desirable for there to be few or no legs, little or no meat pull-off, and little or no transfer of polymer to meat product during stripping of the laminate from the cooked meat product.

Organic solvents useful in making the coating blend/solution include volatile hydrocarbon fluids selected from the group consisting of C₅ to C₁₂ alkanes and alkenes, aliphatic alcohols selected from the group consisting of C₃ to C₆ alcohols, ketones selected from the group consisting of C₃ to C₅ aliphatic ketones, and C₃ to C₁₂ organic esters. Pentane, hexane, heptane, octane, and iso-octane are suitable solvents.

As used herein, the term “substrate”, and the phrase “substrate layer” refer to the portion of the additive delivery laminate which supports the additive delivery layer. Although the substrate or substrate layer can be any article to which the additive delivery layer can be adhered, a preferred additive delivery layer is a thermoplastic article or a cellulosic article. A flexible film is a preferred article. The film can be a monolayer film or a multilayer film. Preferably, the substrate can be heat sealed by bringing uncoated portions of the heat seal layer together under heat and pressure to form a heat seal.

Preferably, the substrate comprises at least one member selected from the group consisting of polyolefin, polyethylene, ethylene/alpha-olefin copolymer, polypropylene, propylene/alpha-olefin copolymer, ethylene/vinyl acetate copolymer, ethylene/unsaturated ester copolymer, ethylene/alpha,beta-unsaturated carboxylic acid, ethylene/alpha,beta-unsaturated carboxylic acid anhydride, metal base neutralized salt of ethylene/alpha,beta-unsaturated carboxylic acid, ethylene/cyclo-olefin copolymer, ethylene/vinyl alcohol copolymer, polyamide, co-polyamide, polyester, co-polyester, polystyrene, polyvinylchloride, polyacrylonitrile, polyurethane, and cellulose.

Film substrates onto which the additive delivery layer is applied may include one or more layers, depending on the desired properties for the film. Preferred substrates are multilayer films, designed to achieve slip, modulus, oxygen barrier, and heat sealability. Polymers useful in making the first layer of a multilayer substrate film include polyolefin, vinylidene chloride copolymer (including vinylidene chloride/vinyl chloride/methyl acrylate copolymer), ethylene homopolymer and copolymer (particularly ethylene/alpha-olefin copolymer), propylene homopolymer, polybutene, butene/alpha-olefin copolymers, ethylene/unsaturated ester copolymer (particularly ethylene/vinyl acetate copolymer), ethylene/unsaturated acid copolymer (including ethylene/acrylic acid copolymer), ethylene/vinyl alcohol copolymer, polyamide, co-polyamide, polyester, co-polyester, and ionomer.

Heat sealable substrate layers may include high density polyethylene (HDPE), high pressure low density polyethylene (LDPE), ethylene/alpha-olefin copolymers (LLDPE and VLDPE), single-site catalyzed ethylene/alpha-olefin copolymers (linear homogeneous and long chain branched homogeneous ethylene/C₃-C₁₀ alpha-olefin copolymers), interpenetrating network polymers (IPNs), substantially spherical homogeneous polyolefins (SSHPEs), polypropylene, polybutylene, butene/alpha-olefin copolymers, propylene/ethylene copolymer, and/or propylene/hexene/butene terpolymer. Additional film layers may be included, i.e., in addition to the seal layer. For example, an O₂-barrier layer (e.g., ethylene/vinyl alcohol copolymer, vinylidene chloride/methyl acrylate copolymer, and/or vinylidene chloride/vinyl chloride copolymer) may be utilized behind the seal layer of the substrate.

Multilayer substrate films useful in practicing the invention include for example a first substrate layer of LLDPE, a second blend layer of 85% EVA and 15% HDPE, a third tie layer of maleic anhydride grafted-LLDPE, a fourth layer of ethylene/vinyl alcohol copolymer, a fifth blend layer of 50% nylon 6 and 50% 6/12 copolyamide, a sixth tie layer of maleic anhydride grafted-LLDPE, a seventh blend layer of 85% EVA and 15% HDPE, and an eighth outer layer of LLDPE. In such an example, layers 2-8 provide the substrate film with oxygen barrier and strength properties in addition to the heat seal property of the first substrate layer.

As used herein, the term “colorant” refers to a substance which imparts color to a product which otherwise would have a different color. Colorants include the various FD&C approved colorants, together with various other colorants. Preferably, the colorant comprises at least one member selected from the group consisting of caramel, maltose, beet powder, spice, soy granules, iron oxide, grape color extract, and carotene.

As used herein, the term “flavorant” refers to a substance that affects the sense of taste, and is synonymous with the noun “flavor”, and includes particulate flavorant additives that modify the flavor of a food composition. Flavorants include, but are not limited to, spices (dehydrated garlic, mustard, herbs), seasoning agents (honey mustard, cumin, paprika, chili, lemon, ginger, coriander, barbecue, dehydrated soy), baked, grilled flavorant (particularly chargrill flavorant), or roasted flavorant, fried flavorant (particularly dry fried flavorant), turkey pan drippings flavorant, dehydrated honey, dehydrated vegetable flavorants (tomato, onion, jalapeno, cayenne, chipotle chile, black pepper, habaneros), sea salt, powdered smoke, liquid smoke, hickory smoke flavorant, applewood smoke flavorant, mesquite smoke flavorant, and encapsulated smoke oil. Flavorants may be obtained from suppliers such as Gold Coast, Red Arrow, or Master Taste.

As used herein, the term “odorant” refers to a substance perceptible to the sense of smell, i.e., a scent. Preferred odorants include those which emit a pleasant aroma (such as a fragrance), or a savory aroma. Odorants include powdered smoke, As used herein, the term “granule”, “granular”, or “granular agent”, comprises agglomerates as well as single particles. For example, the granules may include granules within a range of from about 10 to about 500 microns, such as within a range of from about 15 to about 300 microns, or from about 50 to about 250 microns, or from about 70 to about 200 microns, or from about 75 to about 150 microns. Those of skill in the art appreciate that flavor particles may be useful in larger or smaller sizes, for instance cracked pepper can be larger than 500 micron. Granules as used herein include fine additive particles such as powders. Granules are usually solid, but may include liquid, e.g., the granules can include microencapsulated liquids, such as encapsulated smoke oil. Depending upon the process utilized for preparing the laminate, it may be advantageous to classify the additive granules, e.g., it may be advantageous to utilize granules having a maximum dimension of up to 75 microns, or a maximum dimension of up to 150 microns. Screening and air classification, among other processes, can be employed to classify the granules.

The additive granules can be present at relatively high loading levels, based on the total weight of the additive delivery layer. For example, the additive granules can make up from about 10 to about 90 weight percent of the total weight of the additive delivery layer. Alternatively, the additive granules can make up from about 25 to about 85 weight percent of the additive delivery layer, or from about 50 to about 85 weight percent of the total weight of the additive delivery layer.

The granules may form a portion of the outer surface of the additive delivery layer. The outer surface of the additive delivery layer is the surface of the additive-delivery layer which is not adhered to the substrate, i.e., the surface of the additive delivery layer which is oriented away from the substrate.

At least some of the granules may be adhered directly to the surface of the thermoplastic polymer, or attached to the thermoplastic polymer with an adhesive. At least some of the granules may form at least a portion of an outer surface of the additive layer. At least some of the granules may be partially coated or fully coated with the thermoplastic polymer. At least some of the granules may be partially or fully embedded within the additive delivery layer.

While the term “coated” is used herein with respect to granules no portion of which forms an outer surface of the additive delivery layer, the phrase “partially coated” is used with reference to granules a portion of which is coated and a portion of which forms a portion of the outer surface of the additive delivery layer.

Preferably, the granules extend above that surface of the thermoplastic polymer of the additive delivery layer which is opposite the substrate. While some of the granules may be adhered or embedded to the outer surface of the thermoplastic polymer of the additive delivery layer, other granules may be embedded underneath the outer surface(s) of the thermoplastic polymer of the additive delivery layer. A fully embedded granule which is water-soluble will dissolve from within the additive delivery layer if the water can reach the granule. It may require the dissolution of part or all of an adjacent granule in order for the water to reach a fully embedded granule. A granule which is completely surrounded by the thermoplastic polymer may not dissolve if the thermoplastic polymer does not allow water to reach the embedded granule. Nevertheless, many if not most or even all of the granules will dissolve if a high loading of granules is present in the additive delivery layer.

The color, aroma, and flavor granules as used herein refer to additives that modify the flavor, aroma, and color of a food composition, including but not limited to spices (such as dehydrated garlic, onion, mustard, herbs), seasoning agents (such as dehydrated honey, dehydrated soy sauce, cumin, chili, curry powder, dehydrated lemon, ginger, coriander), flavor concentrates (such as barbecue, grilled, baked, roasted flavor), dehydrated vegetable flavors (such as tomato, jalapeno, cayenne, chipotle, paprika habaneros), sea salt, and smoke flavor concentrates (such as glycoaldehyde, 2,6-dimethoxyphenol, guaiacol, or dehydrated hickory, applewood, and mesquite smoke), caramel, maltose, maltodextrin, beet powder, iron oxide, grape color extract, and carotene. Suppliers of color and flavor granules include vendors such as Gold Coast, Red Arrow, and Master Taste. Powdered caramel is among the preferred additives for use in the present invention. Caramel 602, Caramel 603, Caramel 608, Caramel 622, Caramel 624, Caramel 625, Caramel 900 are among the preferred powdered caramels for use in the present invention.

The polymer components used to fabricate multilayer films according to the present invention may also contain appropriate amounts of other additives normally included in such compositions. These include slip agents such as talc, antioxidants, fillers, pigments and dyes, radiation stabilizers, antistatic agents, elastomers, and the like additives, as known to those of skill in the art of packaging films.

Although the substrate need not be crosslinked, in at least one embodiment, one or more layers of the substrate are crosslinked. Crosslinking may be accomplished by conventional methods including irradiation and the addition of chemical crosslinking agents, as for instance agents initiating free radical reactions when heated or exposed to actinic radiation. In irradiation crosslinking, the laminate is subjected to an energetic radiation treatment, such as corona discharge, plasma, flame, ultraviolet, X-ray, gamma ray, beta ray, and high energy electron treatment, which may alter the surface of the film and/or induce cross-linking between molecules of the irradiated material. The irradiation of polymeric films is disclosed in U.S. Pat. No. 4,064,296, to BORNSTEIN, et. al., which is hereby incorporated in its entirety, by reference thereto. BORNSTEIN, et. al. discloses the use of ionizing radiation for crosslinking polymer present in the film.

Radiation dosages are referred to herein in terms of the radiation unit “RAD”, with one million RADS, also known as a megarad, being designated as “MR”, or, in terms of the radiation unit kiloGray (kGy), with 10 kiloGray representing 1 MR, as is known to those of skill in the art. To produce crosslinking, the polymer is subjected to a suitable radiation dosage of high energy electrons, preferably using an electron accelerator, with a dosage level being determined by standard dosimetry methods. A suitable radiation dosage of high energy electrons is in the range of up to about 16-166 kGy, more preferably about 30-139 kGy, and still more preferably, 50-100 kGy. Preferably, irradiation is carried out by an electron accelerator and the dosage level is determined by standard dosimetry methods. The radiation is not limited to electrons from an accelerator since any ionizing radiation may be used. A preferred amount of radiation is dependent upon the laminate and its end use.

The substrate can also be corona treated. As used herein, the phrases “corona treatment” refers to subjecting the surfaces of thermoplastic materials, such as polyolefins, to corona discharge, i.e., the ionization of a gas such as air in close proximity to a film surface, the ionization initiated by a high voltage passed through a nearby electrode, and causing oxidation and other changes to the film surface, such as surface roughness.

A relatively high loading of water soluble granules in thermoplastic polymer, for example in an amount within the range of from about 20% to about 900% by weight, based on weight of thermoplastic polymer (or from about 50% to 500%, or from about 150% to 350%), is preferably prepared by first dissolving the thermoplastic polymer in an organic solvent, and thereafter adding the granules to the solution to make a slurry comprising the additive granules dispersed in the solution of the thermoplastic water insoluble polymer. This slurry, when applied to the substrate followed by evaporation of the organic solvent, produces a coating on the substrate which becomes the additive delivery layer of the resulting laminate. The evaporation of the organic solvent results in a continuous matrix of the thermoplastic polymer, in which some of the additive granules are embedded below the surface of the thermoplastic polymer, while other additive granules are adhered to the surface of the thermoplastic polymer, these granules projecting above the outer surface of the thermoplastic polymer. Water-soluble granules that are partly or fully dissolved while in contact with a moisture-containing food product transfer additive to the food product.

As used herein, the term “film” is used in a generic sense to include plastic web, regardless of whether it is film or sheet. Preferably, films of and used in the present invention have a thickness of 0.25 mm or less. As used herein, the phrase “packaging article” refers to an article suitable for placing a product therein or thereon, with the article thereafter being further processed so that the product is surrounded by the resulting package. As used herein, the term “package” refers to packaging materials configured around a product being packaged. The phrase “packaged product,” as used herein, refers to the combination of a product that is surrounded by a packaging material.

As used herein, the phrase “laminate” refers to an article having at least two layers. Examples include multilayer film, such as coextruded multilayer film, extrusion coated multilayer film, a monolayer film having a coating thereon, and a multilayer film having a coating thereon, two films bonded with heat or an adhesive, etc. A preferred laminate comprises a substrate layer which is an outer layer of the substrate and which comprises a thermoplastic polymer, and an additive delivery layer, the additive delivery layer comprising a water-insoluble thermoplastic polymer impregnated with granules comprising water soluble colorant, water-soluble odorant, and/or water-soluble flavorant. The substrate layer of the laminate is preferably directly adhered to the additive delivery layer. The substrate film can optionally contain one or more additional film layers, such as an oxygen-barrier layer with or without tie layers in association therewith, additional bulk and/or strength layers, etc. The additive delivery layer is preferably a water permeable layer, i.e. permits water extraction of additives from the additive delivery layer for delivery to an adjacent packaged food. The second additive delivery layer is preferably applied as a coating onto the first substrate film layer.

As used herein, the phrase “outer layer” refers to any layer having less than two of its principal surfaces directly adhered to another layer of the film. The phrase is inclusive of monolayer and multilayer films and laminates. All laminates and all multilayer films have two, and only two, outer layers. Each outer layer has only one of its two principal surfaces adhered to only one other layer of the laminate or multilayer film. In monolayer films, there is only one layer, which, of course, is an outer layer in that neither of its two principal surfaces is adhered to another layer of the film.

As used herein, the phrase “drying,” as used with reference to the process of making the additive delivery laminate, refers to the removal of the organic solvent from the additive delivery slurry to form the additive delivery layer of the laminate. The drying converts the coating of additive delivery slurry on the substrate into a solidified additive delivery layer. The drying can result in an additive delivery layer that does not exhibit substantial blocking, i.e., to avoid sticking to a degree that blocking or delamination occurs, with respect to adjacent surfaces of, for example, a film (including both the same or another film), and/or other articles (e.g., metal surfaces, etc.). Preferably, the dried additive delivery layer has a hydrocarbon solvent content of less than about 5 percent, based on the weight of the outer layer; more preferably, from about 0.0001 to 5 percent; still more preferably, from about 0.0001 to 1 percent; yet more preferably, about 0 percent.

As used herein, the term “seal”, refers to any seal of a first region of a film surface to a second region of the same or another film surface, the seal typically formed by bringing the regions together under pressure and heating each of the film regions to at least their respective seal initiation temperatures to form a heat seal. The sealing can be performed by any one or more of a wide variety of manners, such as using a heated bar, hot air, infrared radiation, ultrasonic sealing, etc., and even the use of clips on, for example, a shirred casing, etc.

The additive delivery laminate can be used in a variety of packaging articles, such as a bag, pouch, casing, tray, and lid.

As used herein, the phrase “cook-in” refers to the process of cooking a product packaged in a material capable of withstanding exposure to long and slow cooking conditions while containing the food product. The cooked product can be distributed to the customer in the original package, or the packaging material can be removed and the food portioned for repackaging. Cook-in includes cooking by submersion in water at 57° C. to 85° C. for 2-12 hours, or by submersion in water or immersion in pressurized steam (i.e. retort) at 85° C. to 121° C. for 2-12 hours, using a film suitable for retort end-use. However, cook-in can include dry heat, i.e. conventional oven temperatures of 300° F. to 450° F., or microwave cooking, steam heat, or immersion in water at from 135° F. to 212° F. for 2-12 hours. Cooking often involves stepped heat profiles.

Preferably, the food is cooked at a temperature of from about 145° F. to 205° F. for a duration of from about 1 to 12 hours. Alternatively, the food product can be cooked at a temperature of from about 170° F. to 260° F. for a duration of from about 1 to 20 minutes, followed by cooking the food product at a temperature of from about 145° F. to 205° F. for a duration of from about 1 to 12 hours.

Preferably, the food product comprises at least one member selected from the group consisting of beef, pork, chicken, turkey, fish, cheese, tofu, and meat-substitute.

Cook-in packaged foods are essentially pre-packaged, pre-cooked foods that may be directly transferred to the consumer in this form. These types of foods may be consumed with or without warming. Cook-in packaging materials maintain seal integrity, and in the case of multilayer films are delamination resistant. In certain end-uses, such as cook-in casings, the laminate is heat-shrinkable under cook-in conditions so as to form a tightly fitting package. Additional optional characteristics of films for use in cook-in applications include delamination-resistance, low O₂-permeability, heat-shrinkability representing about 20-50% biaxial shrinkage at about 185° F., and optical clarity.

During cook-in, the package should maintain seal integrity, i.e., any heat-sealed seams should resist rupture during the cook-in process. Typically, at least one portion of a cook-in film is heat sealable to another portion to form a backseamed tubular casing, or a seamless tubing is used if a seamless casing is being used. Typically, each of the two ends of the tubular casing are closed using a metal clip. The casing substantially conforms to the product inside the casing. Substantial conformability is enhanced by using a heat-shrinkable film about the package contents so as to form a tightly fitting package. In some embodiments, the film is heat-shrinkable under time-temperature conditions of cook-in, i.e., the film possesses sufficient shrink energy such that exposure of the packaged food product to heat will shrink the packaging film snugly around the packaged product, representatively up to about 55% monoaxial or biaxial shrinkage at 185° F. In this manner, product yield is increased by the food product retaining moisture, and the aesthetic appearance of the packaged product is not diminished by the presence of surface fluids known as “purge”.

As used herein, the phrase the term “elevated temperature” as regards the process of heat processing a packaged food product (either cooked or uncooked) above ambient temperature to initiate the delivery of granular additives, refers to the heat treating of a packaged food above ambient temperature in a material capable of withstanding exposure to heat and time conditions while containing the food product, for example heating the food product to a temperature of from about 45° C. to about 250° C., such as from about 50° C. to about 200° C., or from about 55° C. to about 150° C., or about 57° C. to about 125° C., or about 60° C. to about 115° C., or about 65° C. to about 100° C., or such as about 70° C. to about 85° C. Elevated temperature processing of a packaged food may included stepped heat profiles, for example heating at 57° C. for 30 minutes, followed by heating at 60° C. for 30 minutes, followed by heating to 75° C. until reaching the desired internal food temperature.

The additive delivery laminate is useful for packaging both uncooked food product and cooked food product. That is, cooking an uncooked food product packaged in the additive delivery laminate can result in the additive being transferred to the food product during cooking. However, the additive delivery laminate can also be used to package a cooked food product, with the additive transferring to the cooked food product during reheating of the food product. Post-pasteruization conditions can be used to transfer the additive to an already cooked food product.

Laminates useful in the present invention may include monolayer or multilayer substrate films. The substrate film may have a total of from 1 to 20 layers; such as from 2 to 12 layers; or such as from 4 to 9 layers. The substrate film can have any total number of layers and any total thickness desired, so long as the substrate provides the desired properties for the particular packaging operation in which the film is used, e.g. O₂-barrier characteristics, free shrink, shrink tension, optics, modulus, seal strength, etc.

As used herein, the phrases “inner layer” and “inside layer” refer to an outer film layer, of a laminate packaging film contacting a product, or an article suitable for use in packaging a product (such as a bag or casing), which is closest to the product, relative to the other layers of the multilayer film.

As used herein, the phrase “outside layer” refers to the outer layer, of a multilayer film or laminate packaging a product, or an article suitable for use in packaging a product (such as a bag or casing), which is furthest from the product relative to the other layers of the multilayer film.

As used herein, the phrase “free shrink” refers to the percent dimensional change in a 10 cm×10 cm specimen of film, when shrunk at 185° F., with the quantitative determination being carried out according to ASTM D 2732, as set forth in the 1990 Annual Book of ASTM Standards, Vol. 08.02, pp. 368-371, which is hereby incorporated, in its entirety, by reference thereto. A heat-shrinkable film, such as the additive delivery laminate, can have a free shrink of from about 5-70 percent in each direction (i.e., from about 5 to 70 percent in the longitudinal (L) and from about 5 to 70 percent the transverse (T) directions) at 90° C., or at least 10 percent at 90° C. in at least one direction; such as from about 10-50 percent at 90° C.; or from about 15-35 percent at 90° C.

For conversion to bags and casings, the additive delivery laminate can be monoaxially oriented or biaxially oriented. The additive delivery laminate can exhibit a total free shrink at 85° C. of at least 10 percent, or alternatively can exhibit a total free shrink at 85° C. of less than 10 percent. The additive delivery laminate can exhibit a free shrink, at 90° C., of at least 10 percent in each direction (L and T); such as at least 15 percent in each direction. For casing end use, a film has a total free shrink (L+T) of from about 30 to 50 percent at 85° C. For bag end-use, a film has a total free shrink of at least 50% (L+T), such as from 50 to 120%. Alternately, the oriented film article can be heat-set. Heat-setting can be done at a temperature from about 60-200° C., such as 70-150° C. and, such as 80-90° C.

The substrate film used in the present invention can have any total thickness desired, so long as the film provides the desired properties for the particular packaging operation in which the film is used. Preferably, the substrate film used in the present invention has a total thickness, of from about 0.3 to about 15 mils (1 mil=0.001 inch; 25.4 mils=1 mm); such as from about 1 to about 10 mils; or from about 1.5 to about 8 mils. For shrinkable casings, the range from 1.5-8 mils is an example of an acceptable substrate film thickness.

Exemplary substrates which can be coated with the additive delivery coating formulation in accordance with the present invention, which can thereafter be used in accordance with the present invention, include the films disclosed in: (a) U.S. Ser. No. 5,843,502, issued Dec. 1, 1998, in the name of Ram K. Ramesh; (b) U.S. Pat. No. 6,764,729, issued Jul. 20, 2004, in the name of Ram K. Ramesh; (c) U.S. Pat. 6,117,464 in the name of Moore, issued Sep. 12, 2000; (d) U.S. Pat. No. 4,287,151, to ESAKOV, et. al., issued Sep. 1, 1981; and (e) U.S. Ser. No. 617,720, in the name of Beckwith et al., filed Apr. 1, 1996. Each of these documents is hereby incorporated in its entirety, by reference thereto.

The following multilayer structures are exemplary of a variety of layer arrangements of additive delivery laminates. The “coating” layer is the additive delivery layer containing the combination of the additive-containing granules, the water-insoluble thermoplastic polymer, and the polymer toughening agent. All of the layers other than the coating layer represent the substrate portion of the additive delivery laminate. In the following film structures, the individual layers are shown in the order in which they would appear in the laminate.:

seal/coating (food-contact)
seal/O₂-barrier/coating (food contact)
O₂-barrier/seal/coating (food contact)
abuse/seal/coating (food-contact)
abuse/O₂-barrier/seal/coating (food-contact)
abuse/tie/O₂-barrier/tie/seal/coating (food-contact)
abuse/tie/O₂-barrier/polyamide (moisture barrier)/tie/seal/coating
(food-contact)
abuse/tie/polyamide (moisture barrier)/O₂-barrier/tie/seal/coating
(food-contact)
abuse/tie/O₂-barrier/tie/bulk/seal/coating (food-contact)
abuse/bulk/tie/O₂-barrier/tie/bulk/seal/coating (food-contact)

The foregoing representative film structures are intended to be illustrative only and not limiting in scope.

The heat seal layer can have a thickness of from about 0.1 to about 4 mils, or from about 0.2 to about 1 mil, or from about 0.3 to about 0.8 mil. The outer abuse layer can have a thickness of from about 0.1 to about 5 mils, or from about 0.2 to about 3 mils, or from about 0.3 to about 2 mils, or from about 0.5 to about 1.5 mils.

The heat seal layer can comprise at least one member selected from the group consisting of olefin homopolymer, ethylene/alpha-olefin copolymer, ethylene/unsaturated ester copolymer, and ionomer resin.

The outer abuse layer can comprise at least one member selected from the group consisting of polyolefin, polystyrene, polyamide, polyester, polymerized ethylene vinyl alcohol (i.e., hydrolyzed ethylene vinyl acetate copolymer), polyvinylidene chloride, polyester, polyurethane, and polycarbonate.

The O₂-barrier layer can be an internal layer or an external layer. Usually the O₂-barrier layer is an internal layer, and usually it is located between the seal layer and the abuse layer of the substrate material. The O₂-barrier layer comprises a polymer having relatively high O₂-barrier characteristics. The O₂-barrier layer can have a thickness of from about 0.05 to 2 mils, and can comprise at least one member selected from the group consisting of polymerized ethylene vinyl alcohol (EVOH, which is hydrolyzed ethylene vinyl acetate copolymer), polyvinylidene chloride (including vinylidene chloride/methyl acrylate copolymer and vinylidene chloride/vinyl chloride copolymer), polyamide, polyester, polyacrylonitrile, and polyacarbonate.

A multilayer substrate film may optionally further contain a tie layer, also referred to by those of skill in the art as an adhesive layer. The function of a tie layer is to adhere film layers that are otherwise incompatible in that they do not form a strong bond during coextrusion or extrusion coating. Tie layer(s) suitable for use in the film according to the present invention have a relatively high degree of compatibility with (i.e., affinity for) the O₂-barrier layer such as polymerized EVOH, polyamide, etc., as well as a high degree of compatibility for non-barrier layers, such as polymerized ethylene/alpha-olefin copolymers. In general, the composition, number, and thickness of the tie layer(s) is as known to those of skill in the art. Preferably, the tie layer(s) each have a thickness of from about 0.01 to 2 mils. Tie layer(s) each comprise at least one member selected from the group consisting of modified polyolefin, ionomer, ethylene/unsaturated acid copolymer, ethylene/unsaturated ester copolymer, polyamide, and polyurethane.

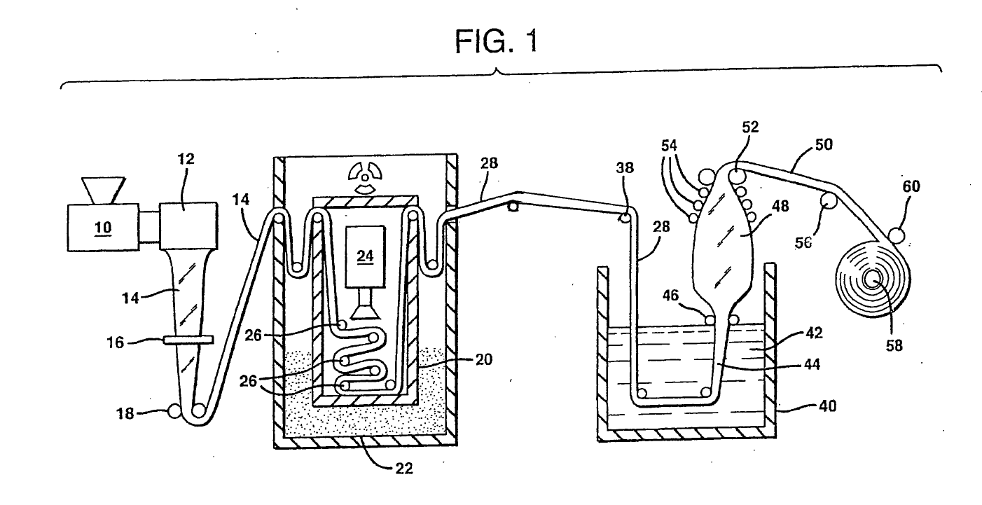

FIG. 1 illustrates a process for making a “substrate film” which can thereafter be coated so that it becomes a film in accordance with the present invention. In the process illustrated in FIG. 1, various polymeric formulations in the form of solid polymer beads (not illustrated) are fed to a plurality of extruders (for simplicity, only one extruder is illustrated). Inside extruders 10, the polymer beads are degassed, following which the resulting bubble-free melt is forwarded into die head 12, and extruded through an annular die, resulting in tubing tape 14 which is preferably from about 15 to 30 mils thick, and preferably has a lay-flat width of from about 2 to 25 inches.

After cooling or quenching by water spray from cooling ring 16, tubing tape 14 is collapsed by pinch rolls 18, and is thereafter fed through irradiation vault 20 surrounded by shielding 22, where tubing 14 is irradiated with high energy electrons (i.e., ionizing radiation) from iron core transformer accelerator 24. Tubing tape 14 is guided through irradiation vault 20 on rollers 26. Preferably, tubing tape 14 is irradiated to a level of from about 40-100 kGy, resulting in irradiated tubing tape 28.

After irradiation, irradiated tubing tape 28 is passed over rollers 38 (rollers 38 included a grid of inventory rollers, not illustrated) after which irradiated tubing tape was passed into a steam oven for a period of from 30 to 90 seconds, i.e., for a time period long enough to bring tubing tape 28 up to the desired temperature for biaxial orientation. The steam oven had an internal temperature of about 235° F. Thereafter, hot, irradiated tubular tape 44 was directed through nip rolls 46, and bubble 48 is blown, thereby transversely stretching hot, irradiated tubular tape 44 so that oriented film tube 50 is formed. Furthermore, while being blown, i.e., transversely stretched, nip rolls 52 have a surface speed higher than the surface speed of nip rolls 46, thereby resulting in longitudinal orientation. As a result of the transverse stretching and longitudinal drawing, oriented film tube 50 is produced, this blown tubing preferably having been both stretched in a ratio of from about 1:1.5 to 1:6, and drawn in a ratio of from about 1:1.5 to 1:6. More preferably, the stretching and drawing are each performed at a ratio of from about 1:2 to 1:4. The result is a biaxial orientation of from about 1:2.25 to 1:36, more preferably, 1:4 to 1:16. While bubble 48 is maintained between pinch rolls 46 and 52, trapped bubble 50 is collapsed by converging pairs of parallel rollers 54, and thereafter conveyed through pinch rolls 52 and across guide roll 56, and then rolled onto wind-up roll 58. Idler roll 60 assures a good wind-up. Before windup, the film can optionally be annealed by being heated to an elevated temperature, such as 165° F., while being restrained from shrinking. Annealing can be carried out by passing oriented film tube 50 over a roller heated to 165° F. to 170° F. Annealing can occur even if the film is heated for only a short period of time, such as from 1 to 15 seconds.

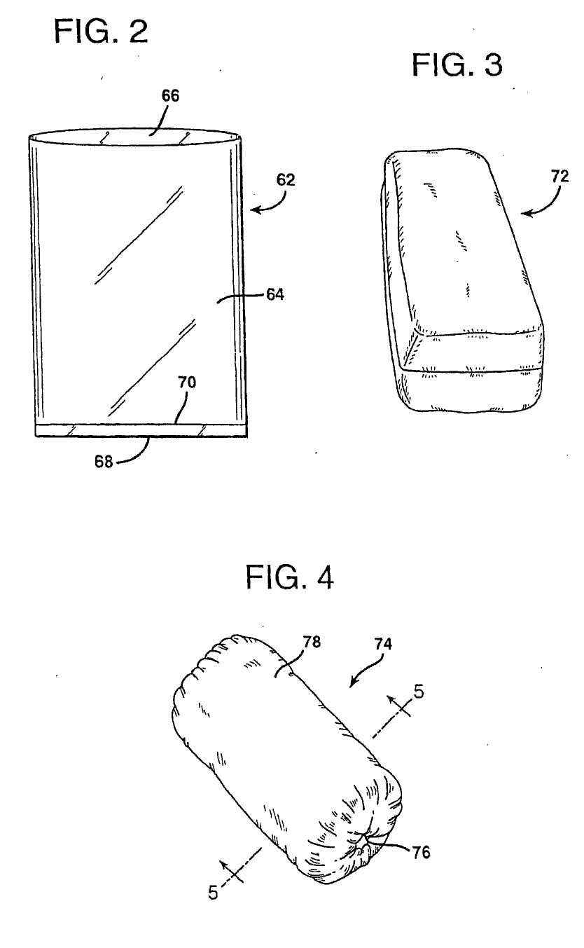

FIG. 2 illustrates bag 62 in lay-flat configuration. Bag 62 is made from film 64, and has open top 66, as well as bottom 68 closed by end-seal 70. Bag 62 has an additive delivery coating on the inside surface thereof (not illustrated) the coating being the inside layer of film 64. An uncooked food product, such as a meat product, is placed inside bag 62, with bag 62 thereafter being evacuated (i.e., vacuumized, to remove the air) and sealed, resulting in packaged meat product 72 illustrated in FIG. 3. The product, which is surrounded by the film, is thereafter cooked while remaining in the film. During cooking, the additive is delivered from the additive delivery layer of the laminate to the outer surface of the cooked product.

FIG. 4 illustrates another embodiment of a packaged product 74 of the present invention, the product being packaged in a casing closed by a pair of clips 76 at each end thereof, with only one clip being illustrated in the perspective view of FIG. 4. Film 78, used to package the meat product inside the casing, can be, for example, Film No. 1 or Film No. 2, discussed in detail below.

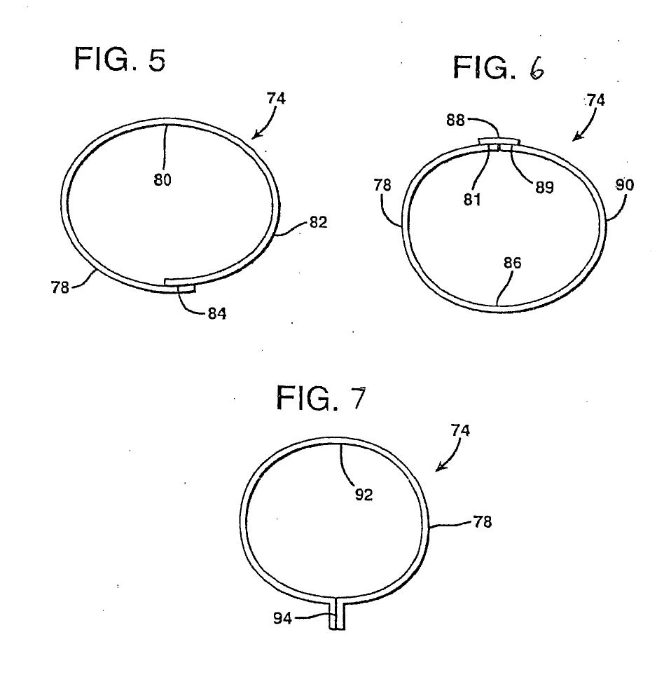

FIGS. 5 illustrates a first cross-sectional view of packaged product 74, i.e., taken through line 5-5 of FIG. 4. FIG. 5 represents a cross-sectional view of a lap-sealed casing comprising film 78 having a coated inside surface region 80, with an uncoated portion heat sealed to outside surface 82 at heat seal 84, the heat seal being located where a first film region overlaps a second film region.

FIG. 6 illustrates an alternative cross-sectional view of packaged product 74, i.e., analogous to the view of FIG. 5 but for a butt-sealed backseamed casing. FIG. 6 represents a cross-sectional view of a butt-sealed backseamed casing comprising film 78 having a coated inside surface region 86. Casing film 78 is heat sealed to butt-seal tape 88. Casing film 78 has inside surface 86 and outside surface 90. Outside surface 90 is heat-sealed to butt-seal tape 88 at seals 87 and 89, where each of the edges of casing film 78 are abutted in close proximity to one another. In this manner, butt-seal tape 88 provides a longitudinal seal along the length of butt-sealed casing film 78. Although butt-seal tape 88 can be made from a monolayer film or a multilayer film, preferably butt-seal tape 88 is preferably made from a multilayer film.

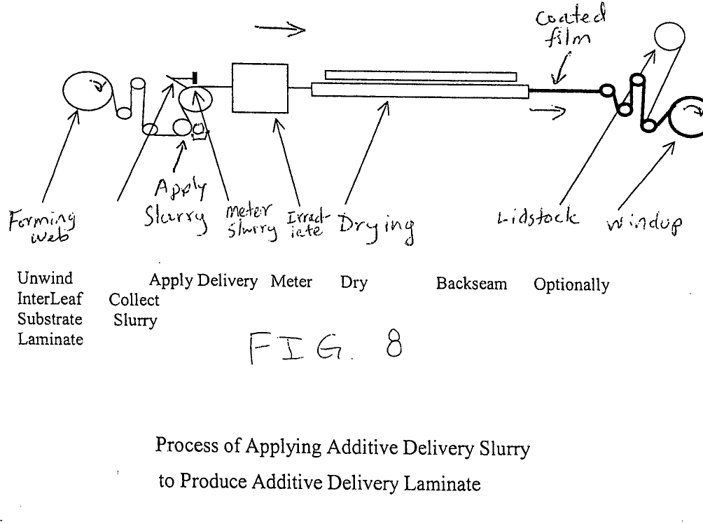

FIG. 7 illustrates a cross-sectional view of a third alternative of packaged product 74, i.e., a fin-sealed backseamed casing. In FIG. 7, fin-sealed casing film 78 has a coated inside surface region 92. Along the edges of the inside surface of casing film 78 are two uncoated regions which are heat sealed to one another at seal 94, which forms a “fin” which extends from casing 74.

The laminate of the present invention can be manufactured using a modified printing or coating process. The additive delivery coating can be applied to a film substrate using printing technology, such as gravure coating or printing, lithographic coating or printing, flood coating followed by metering with a doctor blade, spray coating, etc. Preferably, the coating composition is applied to the film using at least one member selected from the group consisting of gravure roll, flexographic roll, Meyer rod, reverse angle doctor blade, knife over roll, reverse roll coating (including 2-roll, 3-roll, and 4-roll reverse coating), air knife coating, curtain coating, comma roll, lip coating, extrusion coating, spray coating, and screen printing (including rotary screen printing). Screen printing is capable of providing coating weights of from about 15 to about 40 grams/sq. meter. Moreover, screen printing (particularly rotary screen printing) can be used for pattern coating, which will allow manufacture of a backseamed or centerfolded bag.

FIG. 8 is a schematic of a knife-over roll process for continuously coating a substrate with an additive delivery slurry, to make an additive delivery laminate. In the schematic process illustrated in FIG. 8, substrate roll 100 supplies substrate film 102 past rollers 104 to knife-over-roll coating apparatus consisting of formulation hopper 106 containing coating formulation 107, roll 108, and knife 110. The resulting coated substrate 112 passes through dryer 114 wherein the solvent is evaporated. The resulting dried additive delivery laminate 116 can then be rolled up onto windup roll 118. However, as even the dried coating can cause the laminate 116 to block to itself, sacrificial interleaving film 120 can optionally be placed on top of the coated additive delivery laminate 116, to prevent blocking. In another optional step, the dried additive delivery laminate can be backseamed in backseaming apparatus 122 before it is wound up onto windup roll 118.

The additive delivery laminate can be used in a process in which a forming web and a non-forming web are fed from two separate rolls, with the forming web being fed from a roll mounted on the bed of the machine for forming the package “pocket,” i.e., the product cavity. The non-forming (lidstock) web is usually fed from a top-mounted arbor for completing the airtight top seal of the package. Each web has its meat-contact/sealant surface oriented towards the other, so that at the time of sealing, the sealant surfaces face one another. The additive delivery coating can be present on the meat-contact surface of one of both of the forming web and the non-forming web. The forming web can be indexed forward by transport chains, and a previously sealed package can pull the upper non-forming web along with the bottom web as the machine indexes the product stream forward.

The invention is illustrated by the following examples, which are provided for the purpose of representation, and are not to be construed as limiting the scope of the invention. Unless stated otherwise, all percentages, parts, etc. are by weight.

### Preparation of Substrate No. 1

A 18¾″ wide (lay-flat dimension) tube, called a “tape”, having a total thickness of about 27 mils, was produced by the coextrusion process described above and illustrated in FIG. 1, wherein the film cross-section (from inside to outside of the tube) was as follows:

TABLE 1

| | | Layer |
|---|---|---|
| Layer Function(s) | | Thickness |
| and Arrangement | Layer Composition | (mils) |
| Seal | LLDPE#1 | 6.6 |
| strength and | blend of 80% EVA#1 and 15% | 2.7 |
| balance | HDPE#1 and 5% Blue MasterBatch | |
| Tie | anhydride-grafted LLDPE#2 | 1.7 |
| strength and | blend of 50% Nylon#1 and 50% | 0.8 |
| moisture barrier | Nylon#2 | |
| O₂-barrier | 100% EVOH | 1.0 |
| Tie | anhydride-grafted LLDPE#2 | 2.8 |
| strength and | blend of 80% EVA#1 and 15% | 6.4 |
| balance | HDPE#1 and 5% Blue MasterBatch | |
| Outside | blend of 90% LLDPE#1 and 10% | 5.0 |
| | Silica Antiblock | |

wherein:

LLDPE#1 was DOWLEX® 2244A, linear low density polyethylene, obtained from Dow Plastics, of Freeport.

EVA#1 was PE 165 1CS28™ ethylene vinyl acetate copolymer, obtained from Hunstman;

HDPE#1 was FORTIFLEX® T60-500-119 high density polyethylene, obtained from BP;

Blue MasterBatch was 16517-18 Blue, blue pigment in LLDPE carrier, obtained from Colortech.

Anhydride-grafted LLDPE#2 was PX3227 linear low density polyethylene having an anhydride functionality grafted thereon, obtained from Equistar;

EVOH was EVAL® LC-E105A polymerized ethylene vinyl alcohol, obtained from Eval Company of America, of Lisle, Ill.;

NYLON#1 was ULTRAMID® B4 polyamide 6, obtained from BASF corporation of Parsippany, N.J.;

NYLON#2 was GRILON® CF6S polyamide 6/12, obtained from EMS-American Grilon Inc., of Sumter, S.C.; and

Silica Antiblock was 10853 silica in LLDPE from Ampacet.

All the resins were coextruded at between 380° F. and 500° F., and the die was heated to approximately 420° F. The extruded annular tape was cooled with water and placed in a lay-flat configuration, and had a width of 18¾ inches. The tape was then passed through a scanned beam of an electronic cross-linking unit, where it received a total dosage of about 64 kilo grays (kGy). After irradiation, the lay-flat tape was passed through steam (approximately 238° F. to 242° F.) for about 60 seconds. The resulting heated tape was inflated by a trapped bubble technique. The tape was oriented 2.6× in the longitudinal direction (i.e., machine direction) and 3.8× in the transverse direction, while the tape was at a temperature above the Vicat softening point of one or more of the polymers therein, but while the polymers remained in the solid state. The resulting oriented, heat-shrinkable film was then placed in lay-flat configuration. The lay-flat film tubing had a lay-flat width of 63½ inches and a total thickness of about 2.7 mils. The film was then annealed. The trapped bubble was stable and the optics and appearance of the oriented film were good. The film tubing was determined to have about 10% free shrinkage in the longitudinal direction and about 12% free shrinkage in the transverse direction, when immersed in hot water for about 10 minutes, the hot water being at a temperature of 185° F., i.e., using ASTM method D2732-83. The resulting tubing was slit into film.

### Preparation of Substrate No. 2

A 2.4 mil film was made by slitting a tubing made by the process of FIG. 1. The tubing had the following structure:

TABLE 2

| Layer Function(s) | | Layer Thickness |
|---|---|---|
| and Arrangement | Layer Composition | (mils) |
| inside and seal | EPC #1 | 0.53 |
| bulk | VLDPE#1 | 0.51 |
| tie | anhydride-grafted LLDPE#2 | 0.15 |
| O₂-barrier | EVOH | 0.17 |
| tie | anhydride-grafted LLDPE#2 | 0.15 |
| abuse and bulk | blend of 90% EVA#1 and 10% | 0.97 |
| | HDPE#1 | |

EPC#1 was ProFax® SA861 ethylene propylene copolymer, obtained from Bassel.

VLDPE#1 was Exact® 3128 single site very low density polyethylene from Exxon;

Otherwise, each of the resins was as identified in Substrate No. 1, above.

### Preparation of Substrate No. 3

An 18¾″ wide (lay-flat dimension) tube, called a “tape”, was produced by the coextrusion process described above and illustrated in FIG. 1, wherein the film cross-section (from inside to outside of the tube) was as follows:

TABLE 3

| Layer Function(s) | | Layer Thickness |
|---|---|---|
| and Arrangement | Layer Composition | (mils) |
| seal | LLDPE#1 | 6.6 |
| strength | blend of 80% EVA#1 and 20% | 2.7 |
| | HDPE#1 | |
| tie | anhydride-grafted LLDPE#2 | 1.7 |
| strength and | blend of 50% Nylon#1 and 50% | 0.8 |
| moisture barrier | Nylon#2 | |
| O₂-barrier | 100% EVOH | 1.0 |
| tie | anhydride-grafted LLDPE#2 | 2.8 |
| strength and | blend of 80% EVA#1 and 20% | 6.4 |
| balance | HDPE#1 | |
| outside | blend of 90% LLDPE#1 and 10% | 5.0 |
| | Silica Antiblock | |

The resins and other compositions present in each of the various layers of Substrate No. 3 were as identified above in the description of Substrate No. 1. All these resins were coextruded at between 380° F. and 500° F., and the die was heated to approximately 420° F. The extruded tape was cooled with water and flattened, the flattened width being 18¾ inches wide in lay-flat configuration. The tape was then passed through a scanned beam of an electronic cross-linking unit, where it received a total dosage of about 64 kilo grays (kGy). After irradiation, the flattened tape was passed through steam (at approximately 238° F. to 242° F.) for about 60 seconds. The resulting heated tape was inflated into a bubble and oriented (while the tape was at a temperature above the Vicat softening point of one or more of the polymers therein, but while the polymers remained in the solid state) into a film tubing having a total thickness of about 2.7 mils. The bubble was stable and the optics and appearance of the film were good. The resulting tubing was slit into film.

### EXAMPLES 1-7

### (Preparation of Seven Additive Transfer Laminates)

Kraton® G 1650 styrene-ethylene/butylene-styrene triblock copolymer (“SEBS”) was obtained from Kraton Polymers, as well as Kraton® G 1652M SEBS and Kraton® G 1657M SEBS. Various solutions of different concentrations of SEBS in n-hexane were prepared, including 5 weight percent, 10 weight percent, 15 weight percent, and 20 weight percent. For example, a 20 weight percent solution of Kraton® G 1657M SEBS was prepared by adding 100 grams of pelletized Kraton® G 1657M to a sealed glass jar with 400 grams of n-hexane (a petroleum fraction containing various hydrocarbons, but primarily composed of n-hexane). The mixture was heated to approximately 65° C. and agitated until the SEBS was fully dissolved in the n-hexane. To the 10 grams of 20 weight percent SEBS solution was added 3.3 grams of Chardex® 7039 powdered smoke flavor, followed by stirring to create a slurry of the granular additives in the solution of SEBS.

The various formulations were prepared in order to provide different flavor levels and different color intensities. The resulting slurries were stirred to provide homogeneous dispersions. Table 4, below, identifies the various materials used to make up the seven different additive delivery formulations, each containing SEBS dissolved in n-hexane.

TABLE 4

| | | | Chardex ® | Wet Lay-Down |
|---|---|---|---|---|
| | | | 7039 | Thickness of |
| | | SEBS | powdered | SEBS |
| Example | SEBS Solution in | Solution | smoke flavor | Coating |
| No. | n-hexane | (grams) | (gems) | Solution (mils) |
| 1 | 5 wt. % Kraton ® | 20 | 3.3 | 6 |
| | G 1650 | | | |
| 2 | 10 wt. % Kraton ® | 10 | 3.3 | 4 |
| | G 1652M | | | |
| 3 | 15 wt % Kraton ® | 10 | 3.3 | 3 |
| | G 1652M | | | |
| 4 | 20 wt % Kraton ® | 10 | 3.3 | 3 |
| | G 1652M | | | |
| 5 | 10 wt % Kraton ® | 10 | 3.3 | 4 |
| | G 1657 M | | | |
| 6 | 15 wt % Kraton ® | 10 | 3.3 | 3 |
| | G 1657M | | | |
| 7 | 20 wt % Kraton ® | 10 | 3.3 | 3 |
| | G 1657M | | | |

The compositions in Table 4, above, were drawn down using an adjustable coating applicator (described below) set at desired coating thickness (i.e., 3 mils to 6 mils, as set forth in Table 4, above) onto the seal layer of Substrate No. 1, described above. The resulting wet coatings were allowed to air dry. All the compositions in Table 4 dried to a coating that had good adhesion and abuse characteristics as measured by 600-tape adhesion, fingernail scrape resistance and “crinkle” resistance tests.

The tape adhesion test was conducted using #600 tape produced by 3M. The sample tested was graded from 1 to 5, with 5 being no removal of the additive delivery coating. The adhesive side of the tape was manually pressed against the additive delivery coating, with the tape thereafter being pulled off of the additive delivery coating. In order to pass this test, the additive delivery layer had to exhibit 100 percent adhesion, i.e., there should be no visible removal of additive delivery layer from the substrate and onto the #600 tape.

The fingernail scrape resistance test was conducted by scraping across the additive delivery layer with the fingernail. If the coating is readily removed by the scraping action of the fingernail, the laminate fails the fingernail scrape resistance test.

Crinkle was tested using a sample which had been allowed to cure (i.e., dry) for at least 24 hours. Crinkle was conducted by crinkling the sample film between hands 10 times (or until heat is generated). The sample was then laid flat and inspected for disruption of the coating's surface, with any more than slight removal of the coating being considered as failing the test.

The additive delivery laminates were then converted to packaging articles by being heat sealed to themselves to form lap-sealed casings, which were then used to package a thawed (i.e., previously frozen) raw meat emulsion, the ends of the packages being closed with metal clips. The food product was then cooked while packaged in the additive delivery laminate. During cooking, the powdered smoke in the additive delivery layer transferred to the food product, imparting desired color and flavor and aroma to the food product.

### EXAMPLES 8-25

Various additional coating formulations were prepared and thereafter applied to Substrate Film No. 1, described above, to make various additional additive delivery laminates. The difference between the additive delivery laminates of Examples 8-25 and the additive delivery laminates of Examples 1-7 was that the additive delivery layer in each of Examples 8-25 utilized a combination of two different SEBS (i.e., two different SEBS water-insoluble thermoplastic polymers).

For instance, in Example 8, the coating formulation was prepared by dissolving 0.5 gram of Kraton® G1652M SEBS and 0.75 gram of Kraton® G1657M SEBS in 8.75 grams in n-hexane, and thereafter adding 3.3 grams of Chardex® 7039 powdered smoke to the SEBS in n-hexane solution that was then stirred to produce a slurry. The resulting slurry was then applied to the seal layer of Substrate No. 1, in the same manner as described in Examples 1-7 above.

The adjustable coating applicator was obtained from Gardner Lab, Inc., of Bethesda, Md. The stainless steel adjustable coating applicator was made from a rod having a length of 8 inches, and having a machined groove that tapered from 0 to 10 mil in depth. The coating gap was set by aligning marks on steel plates attached by curl nuts on each end of the adjustable coating rod, with the desired gap being marked on the edges of the rod. The applicator was adjusted to apply a coating having a wet lay-down thickness of 3 mils.

As Substrate No. 1 had been slit to a width of approximately 12 inches and the coating applicator was used to apply an 8-inch wide coating to the central portion of the film, Substrate No. 1 was left with uncoated edge portions each of which was about 2 inches in width. After the coating formulation was applied to the film, it was allowed to air dry, resulting in the additive delivery laminate. Once dried, all of the formulations in Table 5 exhibited good adhesion to Substrate No. 1 and good abuse characteristics. Although air drying of the solvent was utilized, solvent evaporation could have been accelerated by placing the coated substrate in a drying oven.

The resulting additive delivery laminates were converted to packaging articles and used to package a meat emulsion that was then cooked in the package, as described above in Examples 1-7. The additive delivery laminate was backseamed (to make a lap-sealed casing) with the coating facing inside the resulting tubing.

While packaged in the casing, the food product was then cooked for 30 minutes at 49° C., followed by 30 minutes at 60° C., followed by 60 minutes at 74° C., to an internal temperature of 67° C. After cooking, the product was cooled, and the casing removed from the cooked meat. The color and flavor/aroma in the additive transfer layer transferred to the meat during cooking. In several of Examples 8-25, it was observed that there was a tendency of one or more of the binders (i.e., Kraton® G1657 SEBS and/or Kraton® G1652M SEBS) to adhere to the meat product. However, based on observation and belief, it was determined that no measurable amount of binder transferred from the substrate to the cooked meat product. In addition, some of the samples were observed to exhibit meat pick-off, i.e., small pieces of meat preferentially adhered to the additive delivery laminate when the casing was stripped from the cooked meat product. Table 5, below, sets forth the composition of the additive delivery laminate for each of Examples 8 through 25, as well as various results obtained using the additive delivery laminate in the preparation of a cooked meat product.

TABLE 5

| | Example No. | | | | | | | | | | | | | | | | | |
|---|---|---|---|---|---|---|---|---|---|---|---|---|---|---|---|---|---|---|
| | 8 | 9 | 10 | 11 | 12 | 13 | 14 | 15 | 16 | 17 | 18 | 19 | 20 | 21 | 22 | 23 | 24 | 25 |
| Hold Time (hours) | 0 | 24 | 0 | 24 | 0 | 24 | 0 | 24 | 0 | 24 | 0 | 24 | 0 | 24 | 0 | 24 | 0 | 24 |
| Solution of 5 wt. % | 10 | 10 | 10 | 10 | 10 | 10 | | | | | | | | | | | | |
| Kraton ® G1657M | | | | | | | | | | | | | | | | | | |
| and 7.5 wt % | | | | | | | | | | | | | | | | | | |
| Kraton ® | | | | | | | | | | | | | | | | | | |
| G1652M in | | | | | | | | | | | | | | | | | | |
| 87.5 wt % n-hexane | | | | | | | | | | | | | | | | | | |
| (grams) | | | | | | | | | | | | | | | | | | |
| Solution of | | | | | | | 10 | 10 | 10 | 10 | 10 | 10 | | | | | | |
| 6.25 wt. % | | | | | | | | | | | | | | | | | | |
| Kraton ® G1657M | | | | | | | | | | | | | | | | | | |
| and 6.25 wt. % | | | | | | | | | | | | | | | | | | |
| Kraton ® | | | | | | | | | | | | | | | | | | |
| G1652M in | | | | | | | | | | | | | | | | | | |
| 87.5 wt. % n-hexane | | | | | | | | | | | | | | | | | | |
| (grams) | | | | | | | | | | | | | | | | | | |
| Solution of | | | | | | | | | | | | | 10 | 10 | 10 | 10 | 10 | 10 |
| 10 wt. % | | | | | | | | | | | | | | | | | | |
| Kraton ® G1657M | | | | | | | | | | | | | | | | | | |
| and 5 wt. % | | | | | | | | | | | | | | | | | | |
| Kraton ® | | | | | | | | | | | | | | | | | | |
| G1652M in | | | | | | | | | | | | | | | | | | |
| 85 wt % n-hexane | | | | | | | | | | | | | | | | | | |
| (grams) | | | | | | | | | | | | | | | | | | |
| Parts Chardex ® | 3.3 | 3.3 | 3.3 | 3.3 | 3.3 | 3.3 | 3.3 | 3.3 | 3.3 | 3.3 | 3.3 | 3.3 | 3.3 | 3.3 | 3.3 | 3.3 | 3.3 | 3.3 |
| 7039 powdered | | | | | | | | | | | | | | | | | | |
| smoke (grams) | | | | | | | | | | | | | | | | | | |
| Emulsion type | H | H | H | H | T | T | H | H | H | H | T | T | H | H | H | H | T | T |
| (H = ham | | | | | | | | | | | | | | | | | | |
| T = turkey) | | | | | | | | | | | | | | | | | | |

Cook-in Results

| | | | | | | | | | | | | | | | | | | |
|---|---|---|---|---|---|---|---|---|---|---|---|---|---|---|---|---|---|---|
| Color | 3-5 | 4 | 5 | 4 | 5 | 4 | 5 | 4 | 5 | 4 | 5 | 4 | 5 | 4 | 5 | 4 | 5 | 4 |
| Meat Adhesion | 5 | 5 | 5 | 3 | 3 | 5 | 5 | 5 | 5 | 1 | 2 | 3 | 5 | 1 | 4 | 1 | 1 | 1 |
| Film Adhesion | 5 | 5 | 5 | 5 | 5 | 5 | 5 | 5 | 5 | 5 | 5 | 5 | 5 | 5 | 5 | 5 | 5 | 5 |
| Purge | 5 | 5 | 4 | 3 | 2 | 4 | 5 | 5 | 5 | 4 | 2 | 2 | 5 | 5 | 4 | 4 | 2 | 5 |
| Casing end-adhesion | 5 | 5 | 5 | 5 | 4 | 4 | 5 | 5 | 5 | 5 | 4 | 4 | 5 | 5 | 4 | 5 | 5 | 5 |
| Pick-off/legs | 5 | 5 | 5 | 5 | 4 | 4 | 5 | 5 | 5 | 5 | 3 | 2 | 5 | 5 | 5 | 5 | 5 | 5 |

KEY:
Color: 1 to 5; 1 = light color; 5 = intense color;
Meat Adhesion: 1 to 5; 1 = no meat adhesion or too much meat adhesion 5 = meat adhesion without meat pick-off;
Film Adhesion: 1 to 5; 1 = coating does not adhere to film, 5 = 100% coating adhesion to film;
Purge: 1 to 5; 1 = high purge level; 5 = no purge, or essentially no purge;
Casing end-adhesion: 1 = coating does not adhere to film; 5 = coating adheres to film;
Legs: 1 to 5; 1 = lots of strings between meat product and coating; 5 = no strings between product and coating

### EXAMPLES 26-42

Additional coating formulations were prepared and thereafter applied to Substrate Film No. 1 (described above) or Substrate Film No. 2 (also described above), as set forth in Table 6, below. However, unlike the procedure used in Examples 1-25, in Examples 26-42 the coating formulation was applied to the substrate film using a Meyer Rod No. 2.5 with a 3 mil shim, to produce a theoretical wet lay-down of 3.25 mils.

Examples 26-42 demonstrate results obtained using different granular size, different concentrations, and different types of Chardex® powdered smoke. The resulting additive delivery laminate was converted to a lap-sealed backseamed casing and used to package a food product, as described in Examples 1-25, above.

Table 6, below, sets forth the composition of the additive delivery laminate for each of Examples 26 through 42, as well as various results obtained using the additive delivery laminate in the preparation of a cooked meat product.

TABLE 6

| | Example No. | | | | | | | | | | | | | | | | |
|---|---|---|---|---|---|---|---|---|---|---|---|---|---|---|---|---|---|
| | 26 | 27 | 28 | 29 | 30 | 31 | 32 | 33 | 34 | 35 | 36 | 37 | 38 | 39 | 40 | 41 | 42 |
| Substrate Film Identity | 1 | 1 | 1 | 1 | 1 | 1 | 1 | 2 | 2 | 2 | 2 | 2 | 2 | 1 | 1 | 1 | 1 |
| Hold Time (hours) | 0 | 24 | 24 | 0 | 24 | 0 | 24 | 0 | 24 | 24 | 24 | 0 | 24 | 0 | 0 | 0 | 0 |
| Solution of 10 wt. % | 10 | 10 | 10 | 10 | 10 | 10 | 10 | 10 | 10 | 10 | 10 | 10 | 10 | 10 | 10 | 10 | 10 |
| Kraton ® G1657M | | | | | | | | | | | | | | | | | |
| and 5 wt. % Kraton ® | | | | | | | | | | | | | | | | | |
| G1652M in 85 wt % | | | | | | | | | | | | | | | | | |
| n-hexane (parts by wt.) | | | | | | | | | | | | | | | | | |
| Parts Chardex ® 7039 | 3.3 | 3.3 | 3.75 | 4.5 | 4.5 | 5.25 | 5.25 | | | | | | | | | | |
| powdered smoke | | | | | | | | | | | | | | | | | |
| (particle size less than 150 | | | | | | | | | | | | | | | | | |
| micron) | | | | | | | | | | | | | | | | | |
| {parts by wt} | | | | | | | | | | | | | | | | | |
| Parts Chardex ® 7039 | | | | | | | | 3.3 | 3.3 | 3.75 | 4.5 | 5.25 | 5.25 | | | | |
| powdered smoke | | | | | | | | | | | | | | | | | |
| (particle size sieved | | | | | | | | | | | | | | | | | |
| to less than 75 micron) | | | | | | | | | | | | | | | | | |
| {parts by wt} | | | | | | | | | | | | | | | | | |
| Parts Chardex ® 9065 | | | | | | | | | | | | | | 3.3 | 3.3 | | |
| powdered smoke | | | | | | | | | | | | | | | | | |
| (particle size sieved | | | | | | | | | | | | | | | | | |
| to less than 150 micron) | | | | | | | | | | | | | | | | | |
| {parts by wt} | | | | | | | | | | | | | | | | | |
| Parts Chardex ® 9065 | | | | | | | | | | | | | | | | 3.3 | 3.3 |
| powdered smoke | | | | | | | | | | | | | | | | | |
| (particles not sieved | | | | | | | | | | | | | | | | | |
| for size) | | | | | | | | | | | | | | | | | |
| {parts by wt} | | | | | | | | | | | | | | | | | |
| meat type | H | H | H | H | H | H | H | H | H | H | H | H | H | H | T | H | T |
| (H = ham emulsion) | | | | | | | | | | | | | | | | | |
| (T = turkey emulsion) | | | | | | | | | | | | | | | | | |

Cook-in Results

| | | | | | | | | | | | | | | | | | |
|---|---|---|---|---|---|---|---|---|---|---|---|---|---|---|---|---|---|
| Color | 5 | 2 | 2 | 5 | 5 | 5 | 5 | 5 | 2 | 2 | 3 | 5 | 3 | N/A | N/A | N/A | N/A |
| Meat Adhesion | 4 | 5 | 5 | 4 | 5 | 4 | 5 | 5 | 4 | 3 | 3 | 4 | 4 | 4 | 1 | 4 | 1 |
| Film Adhesion | 5 | 5 | 5 | 5 | 5 | 5 | 5 | 5 | 5 | 5 | 5 | 5 | 5 | 5 | 5 | 5 | 5 |
| Purge | 2 | 4 | 5 | 2 | 5 | 2 | 5 | 4 | 4 | 2 | 2 | 4 | 5 | 5 | 1 | 5 | 1 |
| Casing end-adhesion | 5 | 5 | 5 | 5 | 5 | 5 | 5 | 5 | 5 | 5 | 5 | 5 | 5 | 5 | 5 | 5 | 5 |
| Pick-off/legs | 5 | 5 | 5 | 5 | 5 | 5 | 5 | 5 | 5 | 5 | 5 | 5 | 5 | 5 | 5 | 5 | 5 |

KEY: same as in Table 5

### EXAMPLES 43-60

Additional coating formulations were prepared and thereafter applied to Substrate Film No. 1 (described above), as set forth in Table 7, below. The procedure for applying the coating formulation to the substrate was the same as described above for Examples 26-42. However, in Examples 43-60, some of the coating formulations were applied to the substrate film using a Meyer Rod No. 2.5 with a 2 mil shim, to produce a theoretical wet lay-down of 2.25 mils, and other coating formulations were applied using a Meyer Rod No. 2.5 with a 3 mil shim, to produce a theoretical wet lay-down of 3.25 mils. In addition, Examples 43-60 demonstrate results obtained using a combination of Caramel 602 alone (i.e., Examples 43 and 44), a combination of Caramel 602 and Maillose Dry (i.e., Examples 45-54), a combination of Caramel 602 and citric acid (Examples 55-57), and a combination of Caramel 602, Maillose Dry, and citric acid (Examples 58-60). The resulting additive delivery laminates were converted to lap-sealed backseamed casings and used to package ham emulsion, in the same manner as described in Examples 1-25, above. Table 7, below, sets forth the composition of the additive delivery laminate for each of Examples 43 through 60, as well as various results obtained using the additive delivery laminate in the preparation of a cooked meat product

TABLE 7

| | Example No. | | | | | | | | | | | | | | | | | |
|---|---|---|---|---|---|---|---|---|---|---|---|---|---|---|---|---|---|---|
| | 43 | 44 | 45 | 46 | 47 | 48 | 49 | 50 | 51 | 52 | 53 | 54 | 55 | 56 | 57 | 58 | 59 | 60 |
| Wet lay-down thickness | 2 | 2 | 2 | 2 | 2 | 2 | 2 | 2 | 2 | 2 | 2 | 2 | 2 | 2 | 2 | 2 | 2 | 2 |
| of coating | | | | | | | | | | | | | | | | | | |
| formulation (mils) | | | | | | | | | | | | | | | | | | |
| Solution of | 10 | 10 | 10 | 10 | 10 | 10 | 10 | 10 | 10 | 10 | 10 | 10 | 10 | 10 | 10 | 10 | 10 | 10 |
| 10 wt. % Kraton ® | | | | | | | | | | | | | | | | | | |
| G1657M and | | | | | | | | | | | | | | | | | | |
| 5 wt. % Kraton ® | | | | | | | | | | | | | | | | | | |
| G1652M in 85 wt % | | | | | | | | | | | | | | | | | | |
| n-hexane | | | | | | | | | | | | | | | | | | |
| (parts by wt.) | | | | | | | | | | | | | | | | | | |
| Caramel 602 obtained | 3 | 3 | 3 | 3 | 3 | 3 | 3 | 3 | 3 | 3 | 3 | 3 | 3 | 3 | 3 | 3 | 3 | 3 |
| from D. D. Williamson | | | | | | | | | | | | | | | | | | |
| {parts by wt} | | | | | | | | | | | | | | | | | | |
| Maillose Dry obtained | 0 | 0 | 0.3 | 0.3 | 0.6 | 0.6 | 0.9 | 0.9 | 1.2 | 1.2 | 1.5 | 1.5 | 0 | 0 | 0 | 0.3 | 0.6 | 0.6 |
| from Red Arrow with | | | | | | | | | | | | | | | | | | |
| particle size sieved to | | | | | | | | | | | | | | | | | | |
| less than 150 micron) | | | | | | | | | | | | | | | | | | |
| {parts by wt} | | | | | | | | | | | | | | | | | | |
| Citric Acid obtained | 0 | 0 | 0 | 0 | 0 | 0 | 0 | 0 | 0 | 0 | 0 | 0 | 0.3 | 0.6 | 0.9 | 0.6 | 0.3 | 0.6 |
| from Archer | | | | | | | | | | | | | | | | | | |
| Daniels Midland | | | | | | | | | | | | | | | | | | |
| (particle size ground and | | | | | | | | | | | | | | | | | | |
| sieved to less than | | | | | | | | | | | | | | | | | | |
| 150 micron) | | | | | | | | | | | | | | | | | | |
| {parts by wt} | | | | | | | | | | | | | | | | | | |
| meat type | H₁ | H₂ | H₁ | H₂ | H₁ | H₂ | H₁ | H₂ | H₁ | H₂ | H₁ | H₂ | H₁ | H₁ | H₁ | H₂ | H₂ | H₂ |
| (H₁ = Greenwood Ham) | | | | | | | | | | | | | | | | | | |
| (H₂ = Tyson Ham) | | | | | | | | | | | | | | | | | | |

Cook-in Results

| | | | | | | | | | | | | | | | | | | |
|---|---|---|---|---|---|---|---|---|---|---|---|---|---|---|---|---|---|---|
| Color | 1 | 1 | 1 | 1 | 4 | 5 | 5 | 5 | 4 | 5 | 5 | 5 | 5 | 5 | 5 | 5 | 3 | 4 |
| Meat Adhesion | 1 | 1 | 1 | 2 | 5 | 5 | 5 | 5 | 5 | 5 | 5 | 5 | 3 | 4 | 4 | 2 | 3 | 2 |
| Film Adhesion | 5 | 5 | 5 | 5 | 5 | 5 | 5 | 5 | 5 | 5 | 5 | 5 | 5 | 5 | 5 | 5 | 5 | 5 |
| Purge | 5 | 5 | 5 | 5 | 5 | 5 | 5 | 5 | 5 | 5 | 5 | 5 | 5 | 4 | 3 | 1 | 3 | 4 |
| Casing end-adhesion | 5 | 5 | 5 | 5 | 5 | 5 | 5 | 5 | 5 | 5 | 5 | 5 | 5 | 5 | 5 | 5 | 5 | 5 |
| Pick-off/legs | 5 | 5 | 5 | 5 | 5 | 5 | 5 | 5 | 5 | 5 | 5 | 5 | 5 | 5 | 5 | 5 | 5 | 5 |

KEY: same as in Table 5

### EXAMPLES 61-69

Additional coating formulations were prepared and thereafter applied to Substrate Film No. 1 (described above), as set forth in Table 8, below. The procedure for applying the coating formulation to the substrate was the same as described above for Examples 26-42. However, unlike the procedure used in Examples 26-42, in Examples 61-69 the coating formulation was applied to the substrate film using a Meyer Rod No. 2.5 with a 3 mil shim, to produce a theoretical wet lay-down of 3.25 mils.

Examples 61-69 demonstrate results obtained using a combination of Caramel 602 with various levels of annatto red colorant obtained from Kalsec to achieve a mottled red brown, similar to an oil fried meat appearance. Flavor was added using Oil Fried Flavor 682208 water-soluble powder obtained from Mastertaste.

A variety of samples were tested in an attempt to find the best color combination. More particularly, in Example 63 Caramel 602 only was used; in Examples 61-62 a combination of Caramel 602 and Kalsec Annatto; in Example 64 a combination of Caramel 602 and Caramel 603 was used with Annatto red colorant obtained from Kalsec Inc. The resulting additive delivery laminate was converted to a lap-sealed backseamed casing and used to package turkey emulsion, as described in Examples 1-25, above. Table 8, below, sets forth the composition of the additive delivery laminate for each of Examples 61 through 69, as well as various results obtained using the additive delivery laminate in the preparation of a cooked meat product

TABLE 8

| | Example No. | | | | | | | | |
|---|---|---|---|---|---|---|---|---|---|
| | 61 | 62 | 63 | 64 | 65 | 66 | 67 | 68 | 69 |
| Wet lay-down thickness of | 3 | 3 | 3 | 3 | 3 | 3 | 3 | 3 | 3 |
| coating formulation (mils) | | | | | | | | | |
| Grams of the following | 10 | 10 | 10 | 10 | 10 | 10 | 10 | 10 | 10 |
| solution: | | | | | | | | | |
| 10 wt. % Kraton ® G1657M | | | | | | | | | |
| and | | | | | | | | | |
| 5 wt. % Kraton ® G1652M | | | | | | | | | |
| in 85 wt % n-hexane | | | | | | | | | |
| Caramel 602 | 1.02 | 0.45 | 1.02 | 0.45 | 1.02 | 1.02 | 1.02 | 1.02 | 1.02 |
| obtained from D. D. Williamson | | | | | | | | | |
| (grams) | | | | | | | | | |
| Caramel 603 obtained from | — | — | — | 0.15 | — | — | — | — | — |
| D. D. Williamson | | | | | | | | | |
| (grams) | | | | | | | | | |
| Kalsec Inc. | 0.3 | 0.3 | 0 | .15 | .15 | .23 | 0.3 | 0.3 | 0.3 |
| Annatto powder 37-175-40 | | | | | | | | | |
| red colorant | | | | | | | | | |
| (not sieved) | | | | | | | | | |
| Mastertaste Inc. oil fried flavor | — | — | — | — | — | — | 1 | 1.5 | 2 |
| 682208 | | | | | | | | | |

meat type: Perdue Turkey emulsion
Cook-in Results

| | | | | | | | | | |
|---|---|---|---|---|---|---|---|---|---|
| Color | 5 | 4 | 2 | 2 | 2 | 4 | 5 | 5 | 5 |
| Meat Adhesion | 4 | 5 | 1 | 1 | 1 | 1 | 5 | 5 | 5 |
| Film Adhesion | 5 | 5 | 5 | 5 | 5 | 5 | 5 | 5 | 5 |
| Purge | 5 | 4 | 5 | 5 | 5 | 5 | 5 | 4 | 4 |
| Casing end-adhesion | 5 | 5 | 1 | 1 | 1 | 1 | 5 | 5 | 5 |
| Pick-off/legs | 5 | 5 | 5 | 5 | 5 | 5 | 5 | 5 | 5 |

KEY: same as in Table 5

What is claimed is:

1. An additive delivery laminate comprising a substrate and an additive delivery layer, the additive delivery layer comprising a water-insoluble thermoplastic polymer and additive granules comprising at least one member selected from the group consisting of colorant, flavorant, and odorant, the water-insoluble thermoplastic polymer comprising a styrene-ethylene/butylene-styrene triblock copolymer having a styrene to ethylene/butylene weight ratio of from 5:95 to 50:50 and a Brookfield Viscosity of from 500 to 100,000 centipoise measured as a 25 weight percent solution in toluene at 77° F., wherein the styrene-ethylene/butylene-styrene triblock copolymer is present in the additive delivery layer in an amount of from about 10 to 90 weight percent based on total layer weight, and the additive granules are present in the additive delivery layer in an amount of from about 90 to 10 weight percent based on total layer weight.

2. The additive delivery laminate according to claim 1, wherein the styrene-ethylene/butylene-styrene triblock copolymer has a styrene to ethylene/butylene weight ratio of from 8:92 to 40:60 and a Brookfield Viscosity of from 1,000 to 20,000 centipoise measured as a 25 weight percent solution in toluene at 77° F., wherein the styrene-ethylene/butylene-styrene triblock copolymer is present in the additive delivery layer in an amount of from about 15 to 50 weight percent based on total layer weight, and the additive granules are present in the additive delivery layer in an amount of from about 85 to 50 weight percent based on total layer weight.

3. The additive delivery laminate according to claim 1, wherein the styrene-ethylene/butylene-styrene triblock copolymer has a styrene to ethylene/butylene weight ratio of from 10:90 to 38:62 and a Brookfield Viscosity of from 2,000 to 8000 centipoise measured as a 25 weight percent solution in toluene at 77° F., wherein the styrene-ethylene/butylene-styrene triblock copolymer is present in the additive delivery layer in an amount of from about 20 to 40 weight percent based on total layer weight, and the additive granules are present in the additive delivery layer in an amount of from about 80 to 60 weight percent based on total layer weight.

4. An additive delivery laminate comprising a substrate and an additive delivery layer, the additive delivery layer comprising a water-insoluble thermoplastic polymer and additive granules comprising at least one member selected from the group consisting of colorant, flavorant, and odorant, the water-insoluble thermoplastic polymer comprising a blend of:
(A) a first styrene-ethylene/butylene-styrene triblock copolymer, the first styrene-ethylene/butylene-styrene triblock copolymer having a styrene to ethylene-butylene weight ratio of up to 20:80 and a Brookfield Viscosity of from 500 to 100,000 centipoise measured as a 25 weight percent solution in toluene at 77° F.; and
(B) a second styrene-ethylene/butylene-styrene triblock copolymer, the second styrene-ethylene/butylene-styrene triblock copolymer having a styrene to ethylene-butylene weight ratio of at least 21:80 and a Brookfield Viscosity of from 500 to 100,000 centipoise measured as a 25 weight percent solution in toluene at 77° F.; and
wherein the first styrene-ethylene/butylene-styrene triblock copolymer is present in the additive delivery layer in an amount of from about 6.7 to 60 weight percent based on total layer weight, and the second styrene-ethylene/butylene-styrene triblock copolymer is present in the additive delivery layer in an amount of from about 3.3 to 30 weight percent based on total layer weight, and the additive granules are present in the additive delivery layer in an amount of from about 90 to 10 weight percent based on total layer weight.

5. The additive delivery laminate according to claim 4, wherein:
(A) the first styrene-ethylene/butylene-styrene triblock copolymer has a styrene to ethylene-butylene weight ratio of up to 17:83 and a Brookfield Viscosity of from 1,000 to 20,000 centipoise measured as a 25 weight percent solution in toluene at 77° F.; and
(B) the second styrene-ethylene/butylene-styrene triblock copolymer has a styrene to ethylene-butylene weight ratio of at least 24:86 and a Brookfield Viscosity of up to 1,000 to 20,000 centipoise measured as a 25 weight percent solution in toluene at 77° F.; and
the first styrene-ethylene/butylene-styrene triblock copolymer is present in the additive delivery layer in an amount of from about 13 to 33.3 weight percent, based on total layer weight, and the second styrene-ethylene/butylene-styrene triblock copolymer is present in the additive delivery layer in an amount of from about 7 to 16.7 weight percent, and the additive granules are present in the additive delivery layer in an amount of from about 80 to 50 weight percent.

6. The additive delivery laminate according to claim 4, wherein:
(A) the first styrene-ethylene/butylene-styrene triblock copolymer has a styrene to ethylene-butylene weight ratio of up to 15:85 and a Brookfield Viscosity of from 2,000 to 8,000 centipoise measured as a 25 weight percent solution in toluene at 77° F.; and
(B) the second styrene-ethylene/butylene-styrene triblock copolymer has a styrene to ethylene-butylene weight ratio of at least 27:83 and a Brookfield Viscosity of from 2,000 to 8,000 centipoise measured as a 25 weight percent solution in toluene at 77° F.; and
the first styrene-ethylene/butylene-styrene triblock copolymer is present in the additive delivery layer in an amount of from about 16.7 to 26.7 weight percent based on total layer weight, and the second styrene-ethylene/butylene-styrene triblock copolymer is present in the additive delivery layer in an amount of from about 8.3 to 13.3 weight percent based on total layer weight, and the additive granules are present in the additive delivery layer in an amount of from about 75 to 60 weight percent based on total layer weight.

7. The additive delivery laminate according to claim 4, wherein:
(A) the first styrene-ethylene/butylene-styrene triblock copolymer has a styrene to ethylene-butylene weight ratio of from 10:90 to 15:85 and a Brookfield Viscosity of from 3,000 to 5,000 centipoise measured as a 25 weight percent solution in toluene at 77° F.; and
(B) the second styrene-ethylene/butylene-styrene triblock copolymer has a styrene to ethylene-butylene weight ratio of from 25:75 to 35:65 and a Brookfield Viscosity of from 1,500 to 2,000 centipoise measured as a 25 weight percent solution in toluene at 77° F.; and
the first styrene-ethylene/butylene-styrene triblock copolymer is present in the additive delivery layer in an amount of from about 16.7 to 26.7 weight percent based on total layer weight, and the second styrene-ethylene/butylene-styrene triblock copolymer is present in the additive delivery layer in an amount of from about 8.3 to 13.3 weight percent based on total layer weight, and the additive granules are present in the additive delivery layer in an amount of from about 75 to 60 weight percent based on total layer weight.

8. The additive delivery laminate according to claim 4, wherein the additive delivery layer is an outer layer of the laminate.

9. The additive delivery laminate according to claim 4, wherein the granules have a particle size of from about 10 to about 500 microns.

10. The additive delivery laminate according to claim 4, wherein the granules comprise at least one member selected from the group consisting of caramel, powdered smoke, fried flavorant, roasted flavorant, grilled flavorant, turkey pan drippings flavorant, and encapsulated smoke oil.

11. The additive delivery laminate according to claim 4, wherein the thermoplastic water-insoluble polymer in the additive delivery layer comprises at least one member selected from the group consisting of butadiene/styrene copolymer, isobutylene/isoprene copolymer, polyisoprene, polyisobutylene, ethylene/vinyl acetate copolymer, ethylene/butyl acrylate copolymer, ethylene/alpha-olefin copolymer, ethylene/vinyl alcohol copolymer, ethylene/propylene copolymer, polybutadiene, polyethylene, polypropylene, polyvinyl acetate, cellulose triacetate, natural rubber, chicle, and balata rubber.

12. The additive delivery laminate according to claim 4, wherein the substrate layer comprises a thermoplastic polymer selected from the group consisting of polyethylene, ethylene/alpha-olefin copolymer, polypropylene, propylene/alpha-olefin copolymer, ethylene/vinyl acetate copolymer, ethylene/ethylenically-unsaturated esters, ethylene/alpha, beta-unsaturated carboxylic acid, ethylene/alpha, beta-unsaturated carboxylic acid anhydride, metal base neutralized salt of ethylene/alpha, beta-unsaturated carboxylic acid, ethylene/cyclo-olefin copolymer, ethylene/vinyl alcohol copolymer, polyamide, co-polyamide, polyester, co-polyester, polystyrene, and cellulose.

13. The additive delivery laminate according to claim 4, wherein the laminate exhibits a total free shrink at 85° C. of at least 10 percent.

14. The additive delivery laminate according to claim 4, wherein the laminate exhibits a total free shrink at 85° C. of less than 10 percent.

15. The additive delivery laminate according to claim 4, wherein the substrate comprises a multilayer film comprising:
(A) a heat seal layer comprising at least one member selected from the group consisting of olefin homopolymer, ethylene/alpha-olefin copolymer, ethylene/unsaturated ester copolymer, and ionomer resin; and
(B) an O₂-barrier layer comprising at least one member selected from the group consisting of ethylene/vinyl alcohol copolymer, polyvinylidene chloride, vinylidene chloride/methyl acrylate copolymer, vinylidene chloride/vinyl chloride copolymer, polyamide, polyester, polyacrylonitrile, and polycarbonate.

16. The additive laminate according to claim 15, further comprising:
(C) a first tie layer between the heat seal layer and the O₂-barrier layer;
(D) an outer abuse layer; and
(E) a second tie layer between the outer abuse layer and the O₂-barrier layer.

17. The additive-delivery laminate according to claim 16, further comprising a moisture barrier layer comprising polyamide, the moisture barrier layer being between first tie layer and the second tie layer.

18. A packaging article comprising an additive delivery laminate adhered to itself or another component of the packaging article, the additive delivery laminate comprising a substrate and an additive delivery layer, the additive delivery layer comprising a water-insoluble thermoplastic polymer and additive granules comprising at least one member selected from the group consisting of colorant, flavorant, and odorant, the water-insoluble thermoplastic polymer comprising a blend of:
(A) a first styrene-ethylene/butylene-styrene triblock copolymer, the first styrene-ethylene/butylene-styrene triblock copolymer having a styrene to ethylene-butylene weight ratio of up to 20:80 and a Brookfield Viscosity of from 500 to 100,000 centipoise measured as a 25 weight percent solution in toluene at 77° F.; and
(B) a second styrene-ethylene/butylene-styrene triblock copolymer, the second styrene-ethylene/butylene-styrene triblock copolymer having a styrene to ethylene-butylene weight ratio of greater than 21:80 and a Brookfield Viscosity of from 500 to 100,000 centipoise measured as a 25 weight percent solution in toluene at 77° F.; and
wherein the first styrene-ethylene/butylene-styrene triblock copolymer is present in the additive delivery layer in an amount of from about 6.7 to 60 weight percent based on total layer weight, and the second styrene-ethylene/butylene-styrene triblock copolymer is present in the additive delivery layer in an amount of from about 3.3 to 30 weight percent based on total layer weight, and the additive granules are present in the additive delivery layer in an amount of from about 90 to 10 weight percent based on total layer weight.

19. The packaging article according to claim 18, wherein the packaging article comprises a member selected from the group consisting of bag, pouch, casing, tray, and lid.
